(19) United States
(12) Patent Application Publication
(10) Pub. No.: US 2013/0291721 A1
(43) Pub. Date: Nov. 7, 2013

(54) FLUIDIZED BED METHOD AND SYSTEM FOR GAS COMPONENT CAPTURE USING LOW PRESSURE DROP DISTRIBUTOR

(71) Applicants: Roy Silverman, Winchester, MA (US); Robert Sandel, Concord, MA (US); Holly Krutka, Centennial, CO (US); Cody Wilson, Highlands Ranch, CO (US); Travis Starns, Parker, CO (US)

(72) Inventors: Roy Silverman, Winchester, MA (US); Robert Sandel, Concord, MA (US); Holly Krutka, Centennial, CO (US); Cody Wilson, Highlands Ranch, CO (US); Travis Starns, Parker, CO (US)

(73) Assignee: ADA-ES, INC., Highlands Ranch, CO (US)

(21) Appl. No.: 13/861,183

(22) Filed: Apr. 11, 2013

Related U.S. Application Data
(60) Provisional application No. 61/622,643, filed on Apr. 11, 2012.

(51) Int. Cl. B01D 53/12

(52) U.S. Cl. CPC B01D 53/12
USPC 95/108; 96/150

(57) ABSTRACT

The present disclosure is directed to a fluidized bed contaminant treatment system comprising plural stacked distributor elements that can be rigidly fixed to a housing surrounding the fluidized bed.

### CROSS REFERENCE TO RELATED APPLICATION

The present application claims the benefits of U.S. Provisional Application Ser. No. 61/622,643, filed Apr. 11, 2012, entitled “Staged Fluidized Beds for CO2 Capture Using Low Pressure Drop Distributor”, which is incorporated herein by this reference in its entirety.

Cross-reference is made to U.S. application Ser. No. 13/441,119, filed Apr. 11, 2012, which is incorporated herein by this reference in its entirety.

### STATEMENT REGARDING FEDERALLY SPONSORED RESEARCH OR DEVELOPMENT

A portion of the project under which this invention was developed was supported by the Department of Energy (DOE) under Award number DE-FE0004343. This project was funded by the DOE National Energy Technology Laboratory's Innovations for Existing Plants (IEP) Program.

### FIELD

The disclosure relates generally to gas stream treatment and particularly to separation of a selected constituent from a gas stream.

### BACKGROUND

The use of fossil fuels for electricity, power, or heat, as well as the extraction of natural gas can create emissions of carbon dioxide (CO₂) and other environmentally harmful gases, such as acid gases. Such emissions are increasingly targeted by regulatory authorities.

For CO₂ in particular, there are many different solid sorbents under development for CO₂ capture from flue gas streams, and, while the entire field is extensive, a few sorbent related patents are mentioned only for reference. For example, Siriwardane discussed amine-treated sorbents (U.S. Pat. No. 6,908,497) that could be used for CO₂ capture at low temperature, which could be regenerated by heating to temperatures in excess of 35° C. In addition, Gray et al. discussed a new method for making low-cost dry amine sorbents (U.S. Pat. No. 6,547,854). Sayari also used amine functionalization of mesoporous silica to create a potential CO₂ sorbent (U.S. Pat. No. 0,616,674). Finally, Tirio proposed the use of an ion exchange resin for CO₂ capture (U.S. Pat. No. 0,088,550).

While the sorbent is important to the effectiveness and costs related to CO₂ capture, the process and related equipment are also of high importance. Several different groups have proposed different process configurations for CO₂ capture. The most relevant works that utilize a temperature swing (possibly in addition to a pressure or partial pressure swing) are discussed. Several proposals have been made to utilize a process where the sorbent remains stationary, such as using fixed beds that can be operated for either adsorption or regeneration (U.S. Pat. No. 6,755,892 and WO 026637). One concern with a fixed bed system is that the actual bed and support structure itself would need to be heated up and cooled down for each regeneration and adsorption step, respectively. This can be avoided by moving the sorbent between separate separator and regenerator vessels. A moving bed system with cross flow was proposed by Pennline et al. (U.S. Pat. No. 6,387,337). While the proposed moving bed system offers low pressure drop, the contact time between the gas and sorbent is low; in addition, heat removal during adsorption is difficult. To increase the contact time between the sorbent and gas and maximize the CO₂ delta loading of the sorbent, Knaebel proposed using a counter-current reactor with internal cooling during adsorption (U.S. Pat. No. 0,230,930). Knaebel also proposed to lower the sensible heat requirements by transferring heat from the hot sorbent after it is regenerated to the cool sorbent entering the separator. While the counter current design would effectively maximize the CO₂ loading on the sorbent, heat and mass transfer in such a system are unlikely to be sufficient to manage the heat generated during the exothermic adsorption and the heat lost due to the endothermic regeneration. Finally, gas/solids contacting in a moving bed system can be inefficient. It is highly desirable for CO₂ and other gas-phase component adsorption/regeneration reactors to demonstrate effective mass and heat transfer.

### SUMMARY

These and other needs are addressed by the various aspects, embodiments, and configurations of the present disclosure. The disclosure is related generally to the use of solid sorbents to remove a target constituent from a gas stream.

A fluidized bed system according to this disclosure can include:

(a) an input to receive a gas stream comprising a target constituent to be removed by a solid sorbent;

(b) a fluidized bed of the sorbent to sorb the target constituent on the solid sorbent;

(c) a distributor positioned below the sorbent bed comprising stacked distributor elements, with a first row of distributor elements being positioned above a second row of distributor elements, an upper distributor element in the first row of distributor elements overlapping an adjacent lower distributor element in the second row of distributor elements; and

(d) an output to output a treated gas stream having a substantially reduced concentration of the target constituent.

A system according to this disclosure can include a distributor positioned below a fluidized solid sorbent bed comprising stacked and substantially fixed distributor elements, with a first row of distributor elements being positioned above a second row of distributor elements, an upper distributor element in the first row of distributor elements overlapping an adjacent lower distributor element in the second row of distributor elements.

A method according to this disclosure can include:

(a) receiving a gas stream comprising a target constituent to be removed by a solid sorbent;

(b) fluidizing a bed of the sorbent with the gas stream to sorb the target constituent on the solid sorbent; and

(c) removing a target constituent-loaded sorbent from the bed, wherein a distributor positioned below the sorbent bed comprises stacked distributor elements, with a first row of distributor elements being positioned above a second row of distributor elements, wherein an upper distributor element in the first row of distributor elements overlaps an adjacent lower distributor element in the second row of distributor elements.

The gas stream, which can for instance be flue gas generated by a coal-fired power plant, natural gas combined cycle power plant, biomass-fired power plant, co-fired power plant, co-production facility, oil or natural gas refinery, or some other industrial-scale gas stream, passes through the fluidized beds while the sorbent moves in the opposite direction through the beds. The gas stream acts as a fluidizing media. Heat generated in the fluidized beds in the separator can be removed using internal cooling.

The distributor elements can be substantially fixed to a housing containing the fluidized bed in response to movement of the fluidized gas.

The distributor elements can be inversely “V”-shaped.

An upper distributor element in the first row vertically can overlap a lower distributor element in the second row.

A base of the upper distributor element in the first row can be spaced from a side of the lower distributor element in the second row.

The fluidizing step can be performed under conditions to produce bubbling bed fluidization.

The solid sorbent can, under the conditions, be a Geldart A material.

A gap between the base of the upper element and side of the lower element is generally a function of the fluidizing gas velocity. In other words, the gap is sufficiently large to enable a fluidizing gas to suspend and mix the solid sorbent particles in the fluidized bed while preventing the sorbent particles from being transported out of the fluidized bed.

An apex of each distributor element can define a line extending substantially a width of the fluidized bed.

The lines defined by a plurality of the distributor elements can be substantially parallel.

A base apex of each distributor element can define a line extending substantially a width of the fluidized bed. The lines defined by a plurality of the distributor elements can be substantially parallel.

An upper distributor element in the first row laterally can overlap a lower distributor element in the second row.

The present disclosure can provide a number of advantages depending on the particular configuration. The distributor can provide a fluidized gas distribution above the distributor that can not only maintain the integrity of the fluidized bed and provide a low pressure drop across the distributor but also provide a substantially well-dispersed and substantially uniform fluidizing gas distribution above the distributor when the gas enters the sorbent particle bed. In some applications, the fluidized bed can optimally operate in the smooth fluidization, bubbling fluidized, or turbulent churning regimes (as desired), which can promote mixing of the sorbent particles (due to movement of the gas bubbles through the bed), provide effective gas/solids contact, and promote effective heat transfer when desired. In other words, the sorbent bed can be well mixed (e.g., modeled as a continuously stirred tank reactor).

These and other advantages will be apparent from the disclosure of the aspects, embodiments, and configurations contained herein.

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase—gas, liquid or solid material. This is a different process from adsorption, since molecules undergoing absorption are taken up by the volume, not by the surface (as in the case for adsorption).

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces) or chemisorption (characteristic of covalent bonding). It may also occur due to electrostatic attraction.

“Ash” refers to the residue remaining after complete combustion of the coal particles. Ash typically includes mineral matter (silica, alumina, iron oxide, etc.).

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

“Biomass” refers to biological matter from living or recently living organisms. Examples of biomass include, without limitation, wood, waste, (hydrogen) gas, seaweed, algae, and alcohol fuels. Biomass can be plant matter grown to generate electricity or heat. Biomass also includes, without limitation, plant or animal matter used for production of fibers or chemicals. Biomass further includes, without limitation, biodegradable wastes that can be burnt as fuel but generally excludes organic materials, such as fossil fuels, which have been transformed by geologic processes into substances such as coal or petroleum. Industrial biomass can be grown from numerous types of plants, including miscanthus, switchgrass, hemp, corn, poplar, willow, sorghum, sugarcane, and a variety of tree species, ranging from eucalyptus to oil palm (or palm oil).

“Coal” refers to a combustible material formed from prehistoric plant life. Coal includes, without limitation, peat, lignite, sub-bituminous coal, bituminous coal, steam coal, waste coal, anthracite, and graphite. Chemically, coal is a macromolecular network comprised of groups of polynuclear aromatic rings, to which are attached subordinate rings connected by oxygen, sulfur, and aliphatic bridges.

A “fluidized bed” is formed when a quantity of a solid particulate substance (usually present in a holding vessel) is placed under appropriate conditions to cause the solid/fluid mixture to behave as a fluid. This is usually achieved by the introduction of pressurized fluid through the particulate medium.

“Fluidization” refers to a process similar to liquefaction whereby a granular material is converted from a static solid-like state to a dynamic fluid-like state. This process occurs when a fluid (liquid or gas) is passed up through the granular material.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

“Particulate” refers to fine particles, such as fly ash, unburned carbon, soot and fine process solids, typically entrained in a gas stream.

“Separating” and cognates thereof refer to setting apart, keeping apart, sorting, removing from a mixture or combination, or isolating.

A “sorbent” is a material that sorbs another substance; that is, the material has the capacity or tendency to take it up by sorption.

“Sorb” and cognates thereof mean to take up a liquid or a gas by sorption.

“Sorption” and cognates thereof refer to adsorption and absorption, while desorption is the reverse of sorption.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a typical waste gas stream treatment with an embodiment of the disclosure downstream of the contaminant removal devices;

FIG. 2 is a block diagram of a separation system according to an embodiment of the disclosure;

FIG. 3 is a block diagram of a separation system according to an embodiment of the disclosure;

FIG. 4 illustrates a distributor according to an embodiment of the disclosure;

FIG. 5 illustrates a bubble cap according to the prior art;

FIG. 6 is a block diagram of a separation system according to an embodiment of the disclosure;

FIG. 7 is a plot of CO₂ loading (grams CO₂/100 grams fresh sorbent) (vertical axis) against CO₂ partial pressure (bar) (horizontal axis) for an experiment;

FIG. 8 is a prior art plot of bed pressure drop Δp (kPa) versus fluidization velocity uₒ (cm/s);

FIG. 9 depicts various fluidization regimes according to the prior art;

FIG. 10, which is prior art, depicts various fluidization regimes as a function of Geldart behavior;

FIG. 11 is a top view of a distributor according to an embodiment of the disclosure;

FIG. 12 is a side view of the distributor of FIG. 11 taken along line B-B;

FIG. 13 is a side view of a fluidized bed using the distributor elements of FIG. 11;

FIG. 14 is an exploded side view of distributor elements of FIG. 11; and

FIGS. 15A-F are side views depicting various distributor element configurations according to the disclosure.

### DETAILED DESCRIPTION

### Overview

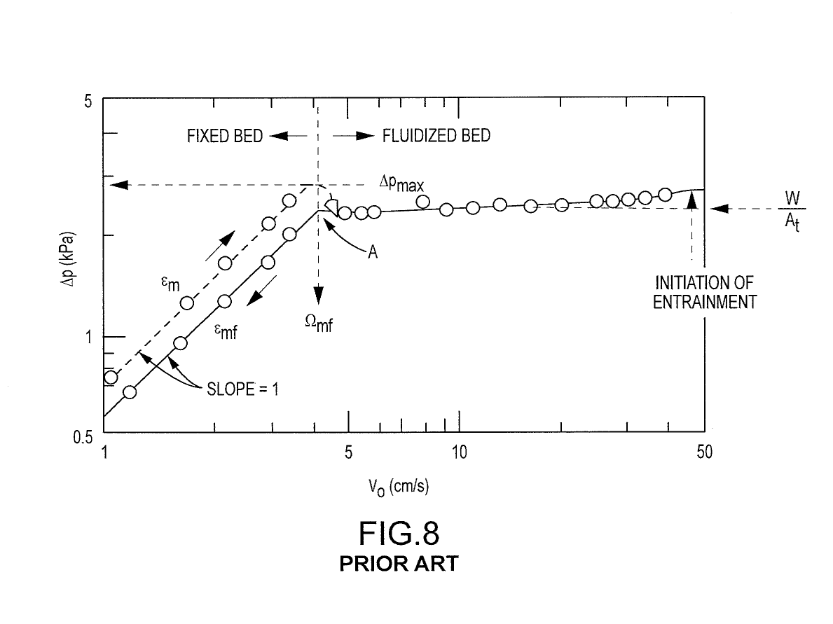

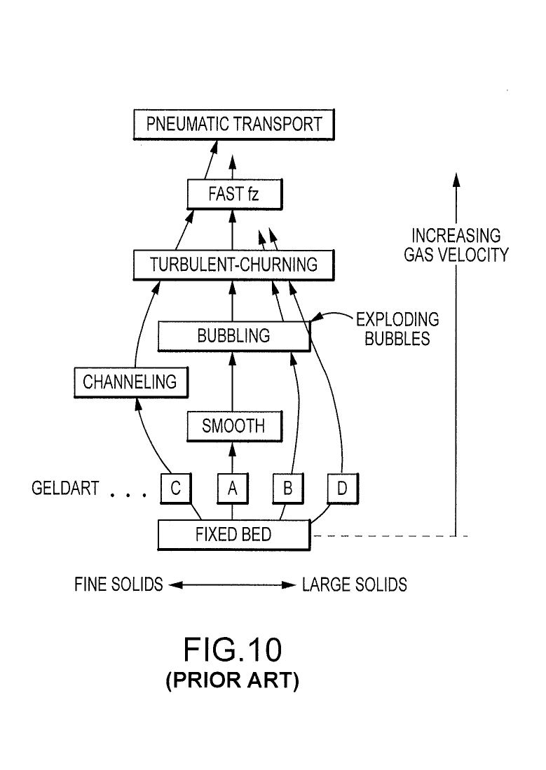

The separation system of the present disclosure uses fluidized beds, particularly plural staged fluidized beds, to provide the mass and heat transfer rates required for sorbent removal or separation of a selected gas constituent, such as CO₂, CO, H₂O, SOₓ, and NOₓ, and/or other sorbable constituent(s), from a gas stream. While not wishing to be bound by any theory, when sorbent particle properties behave as a Geldart A material the bed of sorbent can behave differently based on the gas velocity. As illustrated by FIGS. 8-10, with increasing fluidization gas velocity the sorbent bed will move from a first fluidization regime to a second fluidization regime, as shown below:
fixed or packed bed→particulate (or minimum fluidization)→bubbling bed or fluidization→slug flow or slugging→turbulent fluidization→fast fluidization→pneumatic conveying

The sorbent in the fluidized bed can be any solid or semi-solid (non-liquid) material that sorbs the selected gas stream constituent. For CO₂, for example, the sorbent can be an amine-treated or amine-containing sorbent, an amine functionalized mesoporous or microporous silica, an ion exchange resin, as well as sorbents that do not contain an amine component and rely on physical sorption, and the like.

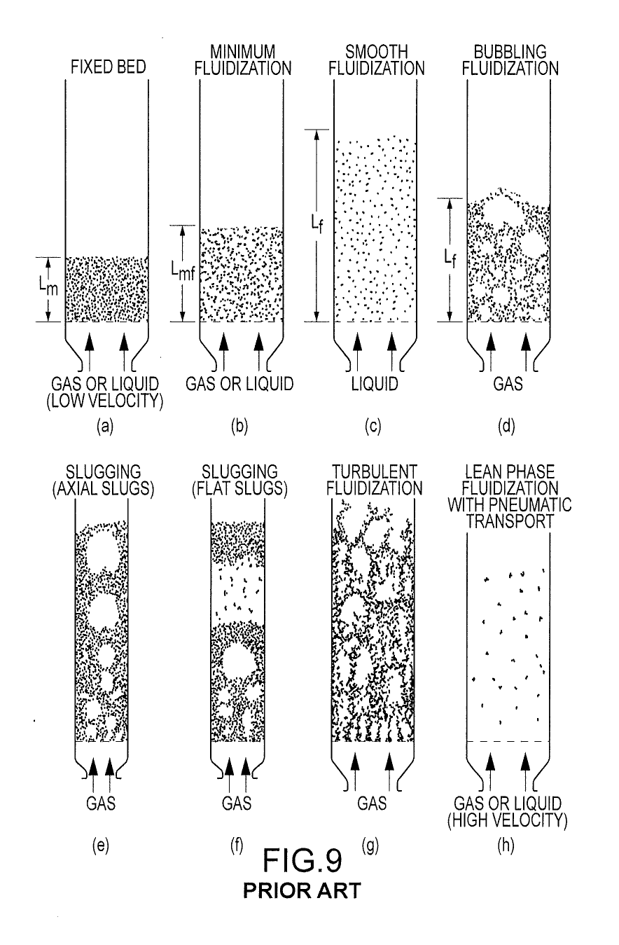

According to one embodiment, the fluidized bed separation system operates in the bubbling fluidization regime, which (as shown by FIG. 9(d)) is commonly characterized by gas bubbles that reach a maximum size and do not continue to grow beyond that size. The movement of the gas bubbles promotes mixing of the sorbent, effective gas/solids contact, and effective heat transfer when desired. In this type of fluidized bed, the bed of sorbent is considered to be well mixed (modeled as a continuously stirred tank reactor (CSTR)).

In one embodiment, the separation system removes CO₂ from a waste or flue gas stream generated by a coal-fired power plant, natural gas combined cycle power plan, co-production facility, biomass-fired power plant, oil or natural gas refinery, or some other industrial-scale gas stream. The separation system uses a dry sorbent-based CO₂ capture process that can remove and add heat as necessary while maintaining effective mass transfer. The process is designed in such a way that it can be utilized for many different potential sorbents. The CO₂, and optionally H₂O, is sorbed onto the sorbent through either chemical and/or physical reaction(s). In one configuration, the CO₂ is sorbed in a vessel called a separator. Once the sorbent has achieved sufficient CO₂ loading it is transferred to a regenerator where an increase in temperature promotes the release of the CO₂.

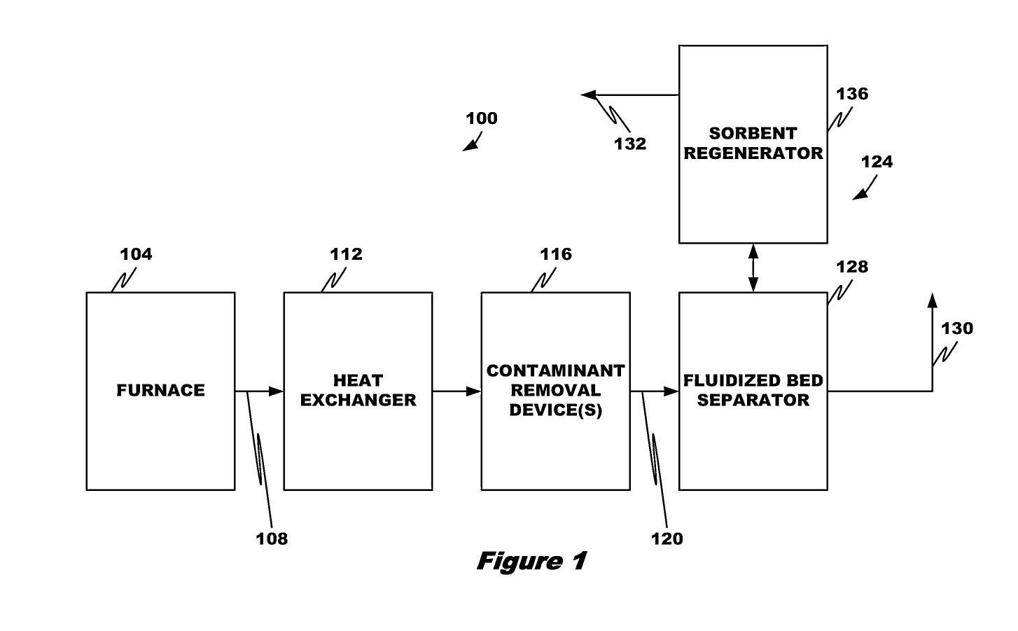

FIG. 1 depicts an exemplary plant 100 for a coal-fired power plant, natural gas combined cycle power plan, co-production facility, biomass-fired power plant, waste incinerator, and the like. A feed material, such as coal, is combusted in a furnace 104, which produces a gas stream 108. The gas stream 108 typically contains many impurities and/or contaminants, including acid gas(es), particulates, elemental and speciated mercury, uncombusted hydrocarbons (such as coal, ash, methane, propane, ethane, and the like), carbon oxides (CO and CO₂), water vapor, and the like. A gas stream comprises typically at least about 1 vol % CO₂ and more typically at least about 5 vol % CO₂ and typically no more than about 15 vol % CO₂ and more typically no more than about 20 vol % CO₂.

The gas stream 108 is passed through a heat exchanger 112 to transfer thermal energy to an oxygen-containing gas to be introduced into the furnace 104 and then through one or more contaminant removal device(s) 116 to remove selected contaminants, such as acid gas(es), particulates, and/or mercury. Common devices for removal of acid gas(es) include dry and wet scrubbers; for removal of particulates include electrostatic precipitators and baghouses; and for removal of mercury include additives, particularly powdered activated carbon and halogens.

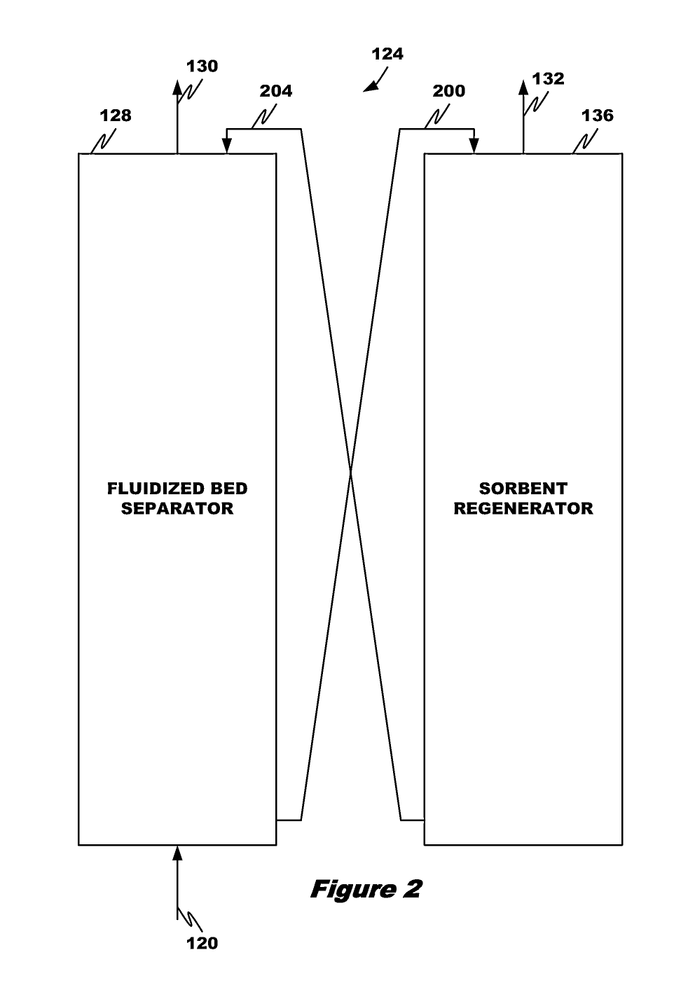

With reference to FIGS. 1 and 2, the treated gas stream 120 is next introduced into a fluidized bed separator 138 of the fluidized bed separation system 124 to remove commonly most, more commonly about 50% or more, and even more commonly about 85% or more of the CO₂ from the treated gas stream 120 and form a purified gas stream 130, a CO₂-rich product gas 132, and a CO₂ loaded sorbent 200. The CO₂ loaded sorbent 200 is introduced into a sorbent regenerator 136 for evolution of the sorbed gas constituent (i.e., CO₂) from the sorbent to form a lean sorbent 204 for recycle to the fluidized bed separator 138 and the CO₂-rich product gas 132.

FIG. 2 depicts a counter-current system where the treated gas stream 120 enters one side of the fluidized bed separator 138 while the CO₂ lean sorbent 204 enters the opposite side. Typically and as shown in FIG. 2, the treated gas stream 120 and sorbent flow counter-currently; that is, the treated gas stream 120 flows upwards, while the lean sorbent 204 travels downwards.

The CO₂ can be evolved by any suitable mechanism, including pressure and/or temperature swing. In the former mechanism, a pressure differential exists between the operating pressures in the fluidized bed separator 138 and the sorbent regenerator 136, which causes the CO₂ to enter the gas phase. In the case where pressure swing is utilized, the operating pressure in the fluidized bed separator 138 is usually greater than the operating pressure in the sorbent regenerator 136. Relative to ambient pressure, the operating pressures can be positive or negative (e.g., under vacuum). In the latter mechanism, a temperature differential exists between the operating temperatures in the fluidized bed separator 138 and the sorbent regenerator 136, which causes the CO₂ to enter the gas phase. Generally, the operating temperature in the fluidized bed separator 138 is less than the operating temperature in the sorbent regenerator 136.

In one configuration, the sorbent regenerator 136 utilizes a change in temperature, total pressure, or partial pressure to regenerate the sorbent and release the CO₂. When a temperature increase is utilized to regenerate the sorbent in the regenerator, the temperature can be increased through direct, indirect, or a combination of direct and indirect heating. The heat input should be sufficient to address both the sensible heat required to change the temperature of the sorbent as well as overcome the enthalpy of reaction required to release the CO₂ and any other sorbed constituents, which may be endothermic. In one application, a sweep gas, either steam or a mixture of steam and CO₂, is injected into the sorbent regenerator 136. In one design, the sorbent regenerator 136 includes plural staged fluidized beds, similar to the fluidized bed separator 128. The CO₂ lean sorbent 204 can be extracted from the last stage (where CO₂ loading is lower than other stages). In another design, the regenerator 136 is a single fluidized bed.

The purified gas stream 130 commonly contains no more than about 1000 ppm, more commonly no more than about 2 vol %, and even more commonly no more than about 10 vol % CO₂. Because most of the other contaminants referenced above have been removed from the gas stream 108 by the contaminant removal device(s) 116, the purified gas stream 130 can be discharged into the atmosphere via a stack (not shown).

A CO₂-rich product gas 132 commonly contains most, more commonly about 75% or more, and even more commonly about 90% or more of the CO₂ removed from the treated gas stream 120. The CO₂-rich product gas 132 commonly has a relatively high purity of CO₂ with a relatively low impurity content. The CO₂-rich product gas 132 typically contains from about 1 vol % to about 99 vol %, more typically from about 25 vol % to about 95 vol %, and even more typically from about 50 vol % to about 90 vol. % CO₂ and from about 1000 ppm to about 90 vol %, more typically from about 1 vol % to about 50 vol %, and even more typically from about 5 vol % to about 15 vol. % water vapor. The balance of the CO₂-rich product gas 132 is comprised of impurities including molecular oxygen, nitrogen, and carbon monoxide.

### Staged Fluidized Beds

As will be appreciated, there are several different approaches to obtaining or approaching counter current gas/solids contacting. The sorbent-to-gas ratio may vary inside the fluidized bed separator 128 depending on fluidized bed hydrodynamics and adsorption kinetics. Preferably, the fluidized bed separation system 124 uses a reactor that not only approaches counter current gas/solids contacting but also demonstrates effective mass and heat transfer that could be utilized for CO₂ capture.

There are several reasons that a standard counter-current system may not be ideal when using solids for CO₂ capture from a large gas stream. For example, the gas/solids mixing may not be sufficient. In addition, the heat transfer could be inefficient, and it may be difficult to design the reactor to include adequate heat transfer surface area; that is, when the sorbent and CO₂ react in an exothermic manner and heat is not removed a temperature bulge is caused. To address the mass and heat transfer concerns while still maximizing the driving force for CO₂ capture, staged fluidized beds are utilized in one embodiment.

Staged fluidized beds can be used to approach counter current contacting (i.e., an infinite number of stages can result in counter current contacting). When staged fluidized beds are used, the size (i.e., diameter or width in the direction perpendicular to the average fluidizing gas flow) of the fluidized bed separator 128 is based on the requisite gas flow rate or gas velocity to fluidize effectively the sorbent particles, thereby providing adequate gas/solids contacting, maximizing heat and mass transfer, and minimizing sorbent entrainment (i.e., bubbling fluidized bed regime). In some cases it may be preferable to use multiple trains to treat a large stream of gas due to limitations on fabrication and manufacturing constraints of vessels with prohibitively large diameters.

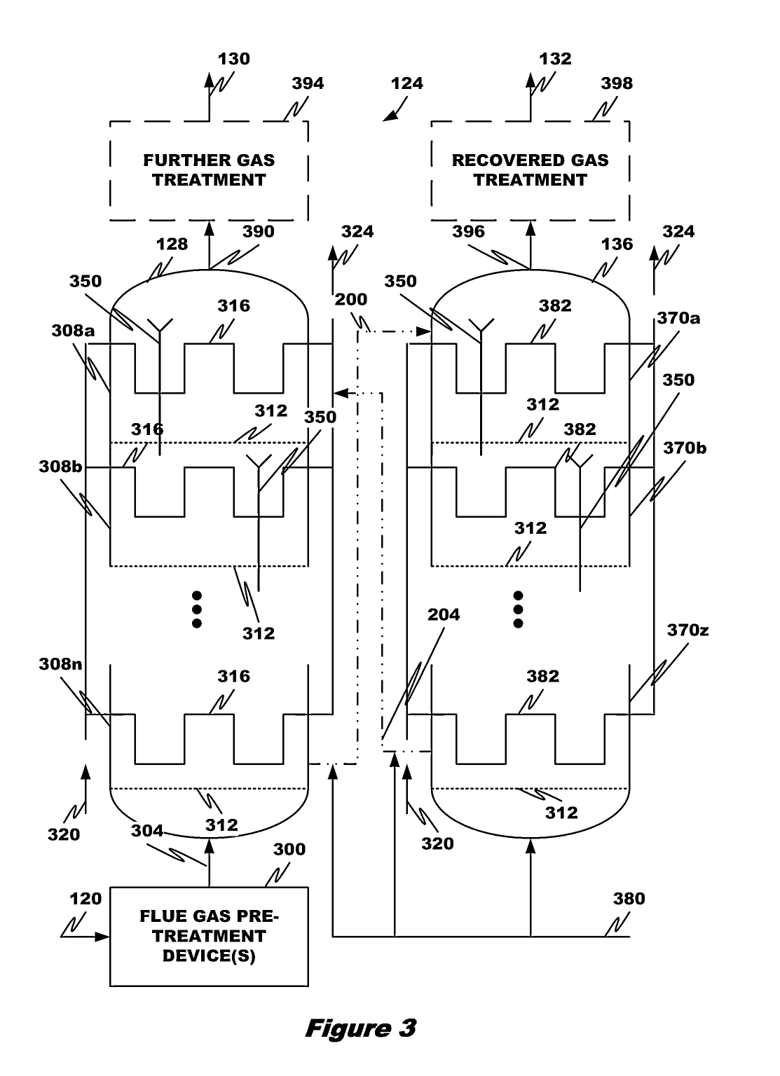

The staged fluidized bed reactor configuration(s) will be discussed with reference to FIG. 3.

The treated gas stream 120 is passed through flue gas pre-treatment device(s) 300 to form a pre-treated gas stream 304. The gas pre-treatment device(s) 300 will be specific to the particular gas being treated. For example, it may be necessary to reduce further concentrations of other constituents, such as SO₂. In addition, it may be desirable to cool and/or increase the pressure of the gas. In some cases, cooling the gas or increasing the pressure could result in the condensation of water out of the gas phase. The gas pressure must be, at a minimum, sufficient to overcome any pressure drop due to the CO₂ capture process. Additional moisture could be removed if desired, but it may not be necessary.

The pre-treated gas stream 304 then enters a lower end of the fluidized bed separator 128 comprising first, second, . . . nth stages 308a-n. The fluidized sorbent beds are commonly staged in such a way that the CO₂ removal may be distributed throughout the vessel. Each stage of the fluidized bed separator comprises a distributor 312 supporting a bed of sorbent particles and a cooling device 316. As the pre-treated gas stream 304 and sorbent particles are contacted, CO₂ in the pre-treated gas stream 304 will be sorbed on the sorbent. Since the reaction between CO₂ and the sorbent is commonly exothermic, the cooling device 316 controls any temperature increase, and attempts to maintain a substantially constant temperature within the bed and across the height of the separator 128, by removing heat.

The distributor 312 separates each of the distinct fluidized bed stages and is designed to support the overlying fluidized bed from the bottom and also redistribute the fluidizing gas as it migrates through the fluidized bed separator 128 vessel. The distributors are also designed to substantially minimize pressure loss as the fluidizing gas passes through the distributor while maintaining substantially a distinct fluid bed level in each stage. These distributors can be substantially optimized to distribute the gas effectively throughout the bed of sorbent. Other features for the distributors include effectively separating entrained sorbent particles, promoting substantially even or uniform gas distribution at lower portion of fluid bed, and supporting sorbent material during abnormal operating conditions.

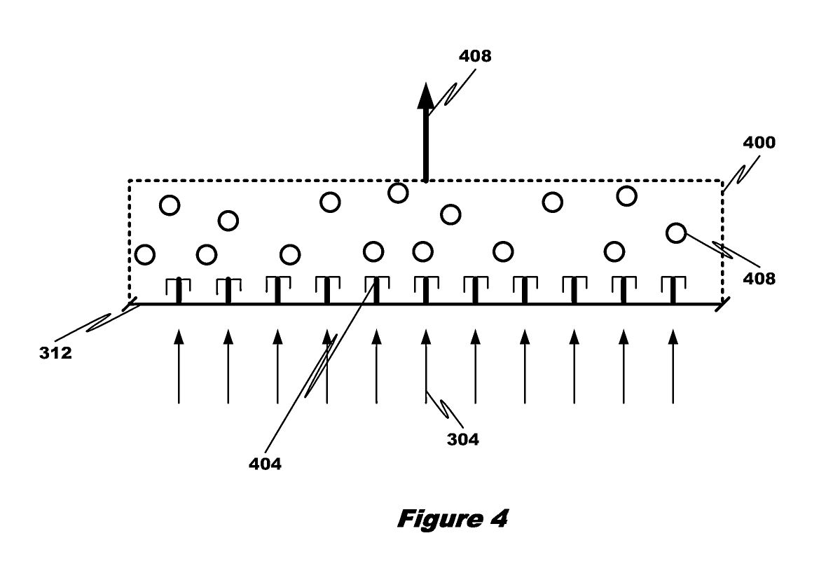

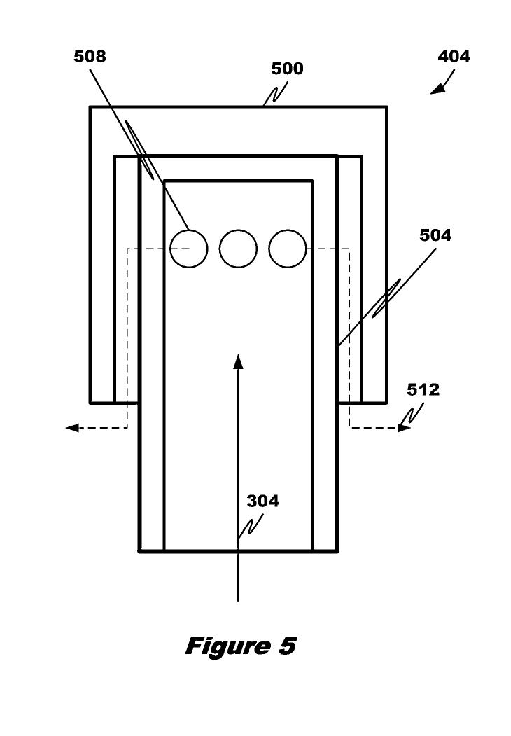

With reference to FIGS. 4-5, the distributor 312, in one configuration, comprises a plurality of bubble caps 404a-k to receive the pre-treated gas stream 304 and fluidize the bed 400 of sorbent particles and form a partially purified gas stream 408. An exemplary bubble cap 404 is illustrated in FIG. 5. The bubble cap 404 includes a cap member 500 and a body member 504. The body member has a plurality of gas passageways 508 around its circumference to pass the pre-treated gas stream 304 circumferentially outward as shown by the dashed line 512. The cap member 500, which may be movable relative to the body member 504, inhibits substantially the sorbent particles from passing through the gas passageways 508 and through the distributor 312.

The diameters of the gas passageways 508 and areal density of bubble caps 404a-k in the distributor 312 depend on the maximum desired pressure loss as the gas passes through the distributor 312, the size and mass of the sorbent particles, and fluidizing gas velocity or flow rate. Under normal operating conditions, the sorbent particle density is commonly in the range of 160 to 1600 kg/m³. The shape of the sorbent can be either spherical or non-spherical. The average particle size is commonly in the range of from about 1 μm to 10 mm. As noted, the sorbent particle bed should be fluidized in the bubbling bed regime, and when the sorbent particles are fluidized, the fluidized bed density of the bed should be 80 to 800 kg/m³. In one application, the bubbles 408 moving upwardly through the bed 400 are commonly substantially uniformly sized, with a typical diameter of the bubbles being in the range of from about 0.05 cm to about 50 cm. The fluidizing gas velocity is commonly in the range of from about 0.1 to about 10 msec. Under these conditions, the cumulative areas of the passageways 508 in each bubble cap 404 commonly ranges from about 0.002 to about 2 cm² and the areal density of bubble caps 404 per m² of distributor 312 area is in the range of from about 100 (for the larger area bubble caps) to about 154,000 (for the smaller area) bubble caps.

Although any suitable cooling mechanism may be employed, the cooling device 316 is generally an indirect heat exchanging device that moves a cooling fluid through the bed 400 to maintain a selected temperature substantially uniformly throughout the bed volume. The adsorption reaction between the sorbent and the CO₂ is commonly exothermic. The cooling device 316 depicted in FIG. 3 is an indirect heat exchanger where the sorbent moves between plates or around tubing that includes a cooling media. As shown in FIG. 3, a (cold-side) cooling fluid 320 is inputted into the various cooling devices 316. The cooling fluid extracts heat from the corresponding bed of sorbent particles and forms a (hot-side) cooling fluid 324. In one configuration the thermal energy collected by the hot cooling fluid 324 is substantially removed, and the cooled cooling fluid recycled as the (cold-side) cooling fluid 320.

The separator vessel height and number of stages should be optimized based on either the CO₂ uptake of the sorbent at different temperatures and CO₂ partial pressures, sorbent kinetics, and/or the heat exchanger surface area required to complete the desired cooling.

While any suitable method may be used to transfer sorbent particles from one bed to another, a common mechanism for moving sorbent particles from an upper bed 400 to a lower bed 400 is through down comers 350, which can be either interior or exterior to the separator 128 vessel or both. As can be seen from FIG. 3, the adjacent down comers 350 are offset from one another and not aligned to prevent short circuiting of sorbent particles.

While the bed depth in each stage is shown as being substantially uniform, the beds may have differing depths. In one configuration, an upper bed, such as the uppermost bed in stage 308a, has a greater depth than a lower bed, such as lowermost bed in stage 308n, to control the operating temperature of the uppermost bed when both sensible heat and latent heat are being removed from the bed. In one configuration the sensible heat for the sorbent to change temperature from the regenerator operating temperature to the separator operating temperature will be removed primarily in the uppermost bed in stage 308a. In another configuration, the bed depths increase gradually and/or progressively along the height of the separator vessel from a lowermost bed in stage 308n to an uppermost bed in stage 308a.

After the sorbent exits the separator 128, it is transferred to the sorbent regenerator 136, which includes a plurality of stages 370a-z, each stage comprising, like the stages 308a-n of the separator 128, a distributor 312 but unlike the separator 128 heating device(s) 382 rather than cooling device(s) 316. The above description of these components applies equally to the sorbent regenerator 136. The heating device(s) 382 can be any suitable heating device, with an indirect heat exchanger being typical. In one configuration, the regenerator 136 is a single fluidized bed. In one configuration, the separator and regenerator vessels are stacked so that no sorbent conveying is necessary between the two vessels. In another configuration, some means of pneumatic, mechanical, or other conveying mechanism transports the sorbent particles between vessels. In either configuration, the sorbent addition and extraction locations in the separator and/or regenerator are separated using one or more baffles.

Although mechanical conveying of the sorbent can be utilized to transfer the sorbent from one reaction vessel to the next, to increase the reliability of the system it is preferable to minimize equipment with moving parts. Therefore, pneumatic conveying is generally used to move the sorbent from the separator 128 to the regenerator 136 and from the regenerator 136 to the separator 128. Referring to FIG. 3, the loaded sorbent particles from the lowermost stage 308n of the separator 128 are conveyed pneumatically to the uppermost stage 370a of the regenerator 136. A carrier gas 380, which may be a slip- or bleed stream of the treated and/or pre-treated gas streams 120 or 304 and/or CO₂-rich product gas 132. In one configuration, a slipstream of the product stream 132 is partly dried and pressurized before being used to convey the sorbent from the separator 128 to the regenerator 136 and from the regenerator 136 to the separator 128. In another configuration, flue gas, CO₂ lean flue gas, steam, nitrogen, or air is to convey the sorbent from the regenerator 136 to the separator 128.

The partially purified gas stream 390 output by the separator 128 and/or an intermediate CO₂-rich product gas stream 396 output by the regenerator 136 may require additional treatment. For example, it is possible that particulate matter may be present in either of the gas streams. In one configuration, the gas stream 390 exiting the first stage of the separator 128 (i.e., the stage with the lowest gas phase CO₂ partial pressure) travels through one or more cyclones in an optional further gas treatment stage 394. The cyclones are designed to capture entrained sorbent and any sorbent captured by the cyclones will be returned to the last stage of the separator 128. If any sorbent is too fine to be captured by the cyclones, a fabric filter, electrostatic precipitator, or some other means of particulate matter control may be used to control particulate emissions and capture sorbent fines. Similarly, in one configuration the gas stream 396 exiting the regenerator 136 travels through one or more cyclones in an optional recovered gas treatment stage 398 and sorbent captured by the cyclones is returned to the last stage of the regenerator 136. The cyclones are designed to capture entrained sorbent and any sorbent captured by the cyclones will be returned to the last stage of the regenerator 136. If any sorbent is too fine to be captured by the cyclones, a fabric filter, electrostatic precipitator, or some other means of particulate matter control may be used to control particulate emissions and capture sorbent fines. After the particulate matter control, in one configuration a substantial amount of the moisture is condensed out of the gas stream 396 by either pressure or thermal means. In one configuration, some of the dried gas stream 132 is used to fluidize the regenerator and/or convey sorbent between any of the vessels.

The regenerator 136 utilizes a change in temperature, pressure, or partial pressure to regenerate the sorbent and release the sorbed CO₂. When a temperature increase is utilized to regenerate the sorbent in the regenerator 136, the temperature can be increased through direct, indirect, or a combination of direct and indirect heating. The heat input should be sufficient to address both the sensible heat required to change the temperature of the sorbent as well as overcome the enthalpy of reaction required to release the CO₂ and any other sorbates, which may be endothermic. The operating temperature of the separator 128 is commonly in a range of from about 25° C. to about 500° C. and even more commonly of from about 30 to about 80° C. while the operating temperature of the regenerator 136 is commonly in a range of from about 35 to about 600 and even more commonly of from about 80 to about 150° C. The operating temperature difference between the separator 128 and the regenerator 136 is commonly in the range of from about 5 to about 300 and more commonly in the range of from about 60 to about 100° C. When a pressure change is utilized to regenerate the sorbent in the regenerator 136, the (total) operating pressure in the separator 128 is commonly in a range of from about 1 to about 150 and even more commonly of from about 1 to about 80 atm while the operating pressure of the regenerator 136 is commonly in a range of from about 0.5 to about 100 and even more commonly of from about 1 to about 20 atm. When a pressure change is utilized the operating pressure difference between the separator 128 and the regenerator 136 is commonly in the range of from about 0.5 to about 80 and more commonly in the range of from about 0.5 to about 10 atm. In one configuration, a sweep gas, either steam or a mixture of steam and CO₂, is injected into the regenerator 136. In the case of the staged fluidized bed regenerator 136, the CO₂ lean sorbent is extracted from the last stage 370z (where CO₂ loading is lower than the other stages).

The fluidizing gases of the separator 128 and regenerator 136 are different. In the separator 128, the fluidizing gas is the gas stream 304 from which separation of CO₂ or some other constituent is desired. In the regenerator 136, the fluidizing gas is CO₂, steam, an inert gas, or a combination thereof.

### The Low Pressure Drop Distributor Configuration

While the above distributor design can be highly effective in many applications, pressure drop can remain a concern. Frequently, effecting gas/solids contacting at industrial scale requires as low a decrease in gas pressure, or pressure drop, over the fluidized bed separator as possible. As noted, the distributor in fluidized beds is responsible for allowing gas to flow upwards while substantially minimizing the ability of the sorbent particles to flow downwards. While bubble cap distributors can maintain the integrity of fluidized bed, it can result in an unacceptably high pressure drop. In designing a distributor providing an optimal or near optimal level of performance, it is desirable to allow the gas to enter the fluidized bed from the bottom, limit the amount of sorbent that can pass downward through the distributor during operation, limit the amount of entrained sorbent particles carried from one distributor to the next (in staged fluidized beds), and cause a smaller loss in pressure compared to bubble cap distributors.

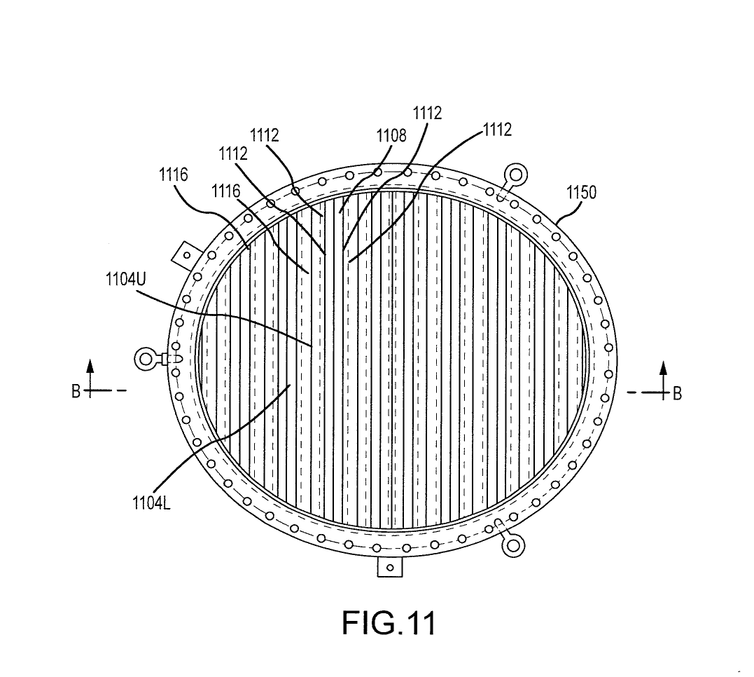

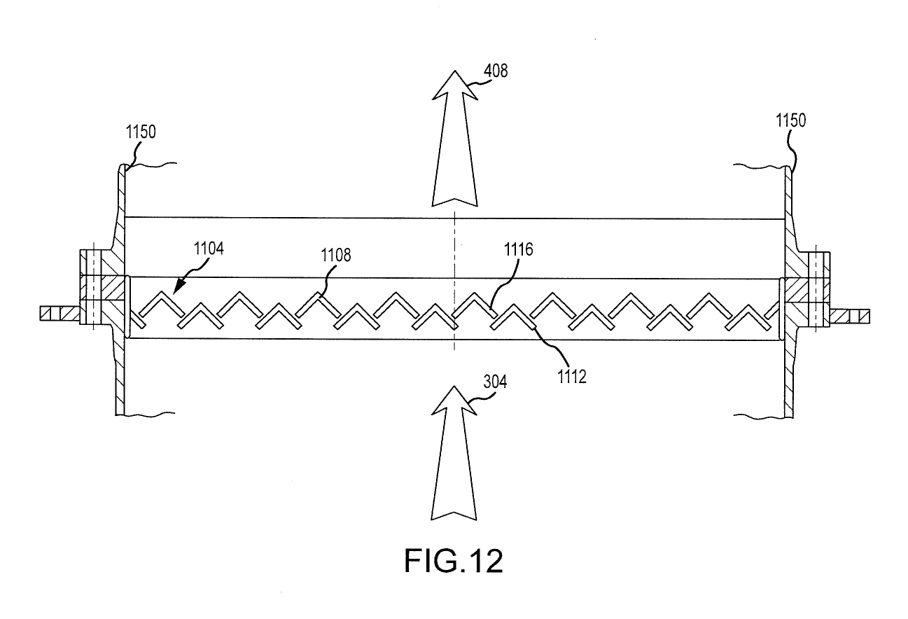

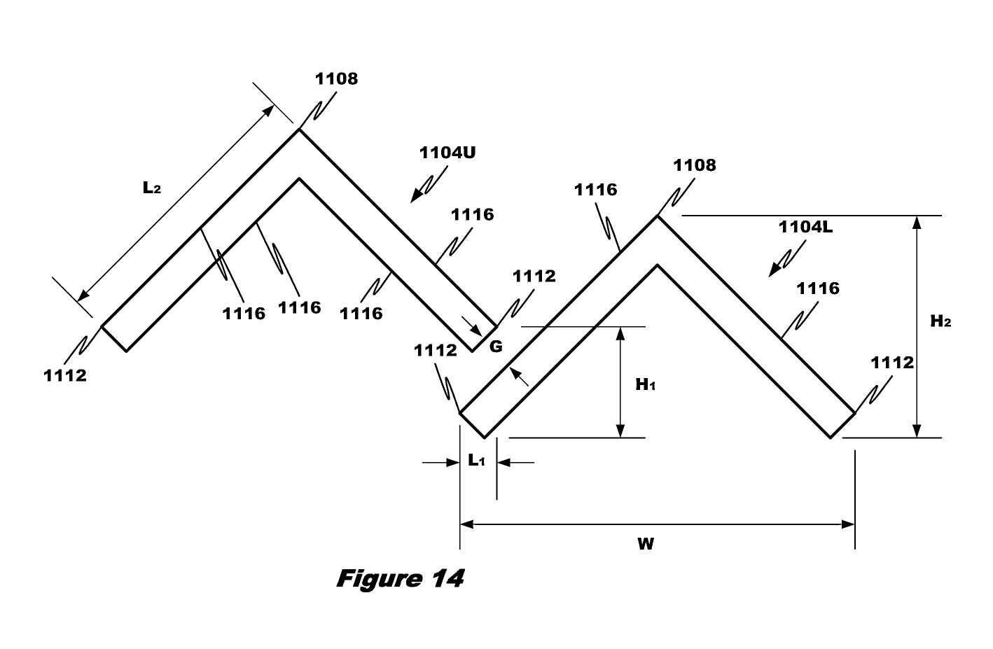

A distributor that can realize the design objectives is illustrated in FIGS. 11-14.

The distributor 1100 includes plural rows of inverted and elongated “V”-shaped (or chevron-shaped) elements 1104. The chevron-shaped elements 1104 are stacked in that every other element 1104U is positioned above the adjacent element 1104L and vice versa. The apex 1108, or top, of each chevron-shaped element 1104 is generally located equidistant between the apexes 1108, or tops, of each adjacent chevron-shaped element 1104 on either side of any selected chevron-shaped element 1104. The apexes 1108 are substantially linear along a length of the corresponding chevron-shaped element 1104, with the apexes 1108 of the chevron-shaped elements being substantially parallel to one another along their lengths. The bases 1112, or bottoms, of each chevron-shaped element 1104 are generally offset laterally and interiorly from the adjacent base 1112 of the adjacent chevron-shaped element 1104. As in the case of the apexes 1108, each base 1112 is substantially linear along a length “L₁ “of the corresponding element 1104 and are parallel with one another and with the apexes 1108. The sides 1116 on either side of the respective apex 1108 are generally of substantially the same length “L₂”. The sides 1116 to a first (left) side of the corresponding apex 1108 are mutually parallel as well as the sides 1116 to an opposing second (right) side of the corresponding apex 1108. Unlike bubble cap distributor elements, the chevron-shaped elements are rigidly attached to the fluidized bed housing 1150 and do not move in response to fluidization gas 304 movement or are substantially rigid and unmovable during operation.

The number and dimensions of the distributor elements 1104 depend on the gas 304 (fluidizing) velocity, desired pressure drop, sorbent particle size and size distribution, and other factors known to those of ordinary skill in the art. The gap “G” between each base 1112 of an upper chevron-shaped element 1104U and an adjacent side 1116 of a lower chevron-shaped element 1104L is generally sufficient to provide a fluidizing gas velocity sufficient to substantially suspend, tumble, and/or mix the solid sorbent particles while maintaining the solid sorbent particles in, and not entraining and transporting the particles out of, the fluidized bed. The gap “G”, in other words, is sufficiently large to inhibit typically at least most, more typically at least about 75% and even more typically at least about 95% sorbent particles from being entrained in the fluidized gas and removed from the fluidized bed with the gas and from trickling back through the distributor (countercurrent to the fluidizing gas flow). A height “H₁” of an upper chevron-shaped element 1104U above a base 1112 of an adjacent lower V-shaped element is generally at least about 50%, more generally at least about 30%, and even more generally at least about 5% of a height “H₂” of the chevron-shaped elements 1104. An offset distance “L₁” of an upper chevron-shaped element 1104U relative to adjacent lower chevron-shaped element 1104L is generally no more than about 10%, more generally from about 5 to about 20%, and even more generally no more than about 25% of a width “W” of the adjacent chevron-shaped elements. Generally, the dimensions of each chevron-shaped elements 1104 are generally substantially uniform for at least most of the elements.

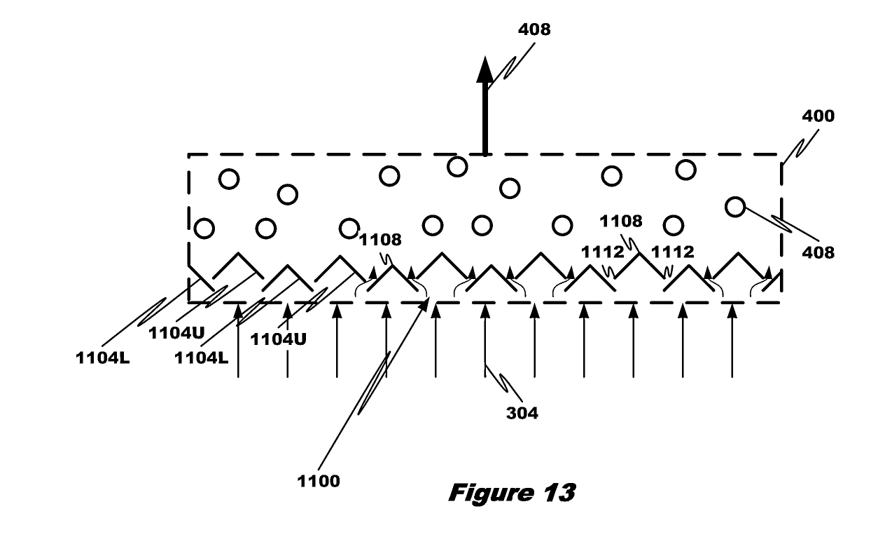

Referring to FIG. 13, the resulting fluidized gas distribution above the distributor 1100 can not only maintain the integrity of the fluidized bed and provide a low pressure drop across the distributor but also provide a substantially well-dispersed and substantially uniform fluidizing gas distribution above the distributor when it enters the sorbent particle bed. In some applications, the fluidized bed can optimally operate in the smooth fluidization, bubbling fluidized, or turbulent churning regimes (as desired), which can promote mixing of the sorbent particles (due to movement of the gas bubbles through the bed), provide effective gas/solids contact, and promote effective heat transfer when desired. In other words, the sorbent bed can be well mixed (e.g., modeled as a continuously stirred tank reactor).

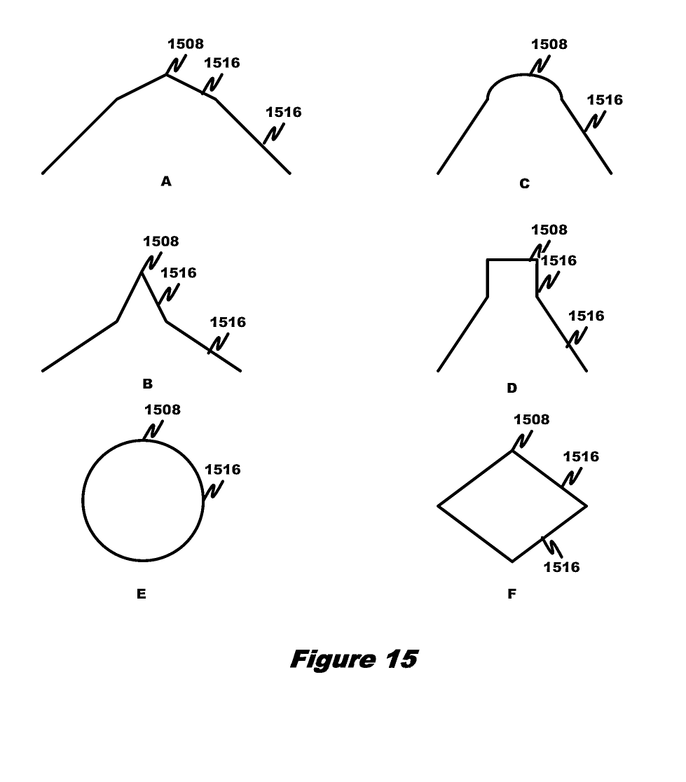

While the distributor 1100 is discussed with reference to a chevron shape, it is to be understood that the shape may have other shapes. For example, the elements can have any of the shapes shown in FIGS. 15A-F. All of the various element shapes have angled and transversely oriented opposing sides 1516 or arcuate opposing ides 1516 meeting at an apex 1508. The angled or arcuate sides 1516 generally direct the gas as shown in FIG. 13.

While the distributor 1100 is discussed with reference to acid gas and carbon dioxide sorption, it is to be understood that the distributor 1100 can be used for any fluidized bed application. It is further to be understood that the distributor 1100 can be used not only for staged fluidized beds but also for single fluidized beds.

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

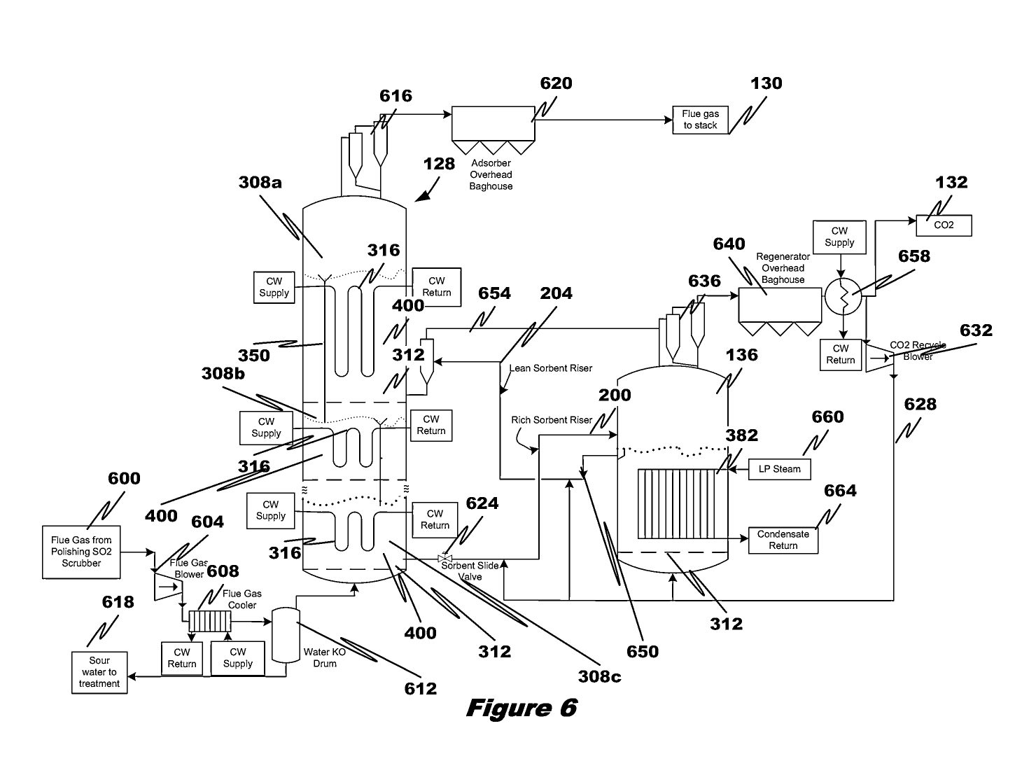

One specific configuration of the invention is shown in FIG. 6. The configuration shown in FIG. 6 is provided only as one possible example of the equipment and process arrangement and should not be considered limiting in any way.

Flue gas from a coal-fired power plant immediately upstream of the stack (i.e., downstream of all other air pollution control equipment) is sent through a (CO₂ capture) fluidized bed separation system 124. In the case of a 550 MW (net basis) coal-fired power plant, one to ten trains of the fluidized bed separation system 124 may be necessary to remove 90% of the CO₂. For the case of one particular sorbent used in this example, the number of required trains is four. These trains will be similar in configuration, so only one is described.

In this example the flue gas 600 is slightly above atmospheric pressure, and at a temperature of 55° C. Also, the fluidized bed separation system 124 is downstream of one or more SO₂ scrubbers (not shown). A flue gas blower 604 is used to increase the pressure of the flue gas 600 so that the pressure is high enough to move through the separator 128. The pressure should be varied based on the sorbent properties, bed height, and many other factors. The flue gas blower 604 increases the temperature of the flue gas, which can be undesirable for CO₂ capture, so a flue gas cooler 608 is used to reduce the temperature of the flue gas to approximately the same temperature as the desired operating temperature in the separator. Cooling water (annotated as “CW” in the figure) in an indirect heat exchanger 316 is used to reduce the flue gas temperature. “CW Return” refers to the hot-side or heated CW, while “CW Supply” refers to the cold-side or cooled and recycled CW. A water knockout drum 612 is used to collected condensation as necessary, with the collected condensation being sour water 618 for further treatment. The flue gas 600 enters the separator 128 at the last fluidized bed stage 308c. The number of fluidized beds in the separator 128 is based on sorbent properties. Because there is an exothermic reaction between the sorbent and the CO₂ in the flue gas heat exchange, cooling device(s) 316, in the form of heat exchange tubes, are included in the fluidized bed(s) 400. Cooling water can be used inside the tubing to remove the heat of reaction; by this mechanism the fluidized bed can operate isothermally or near isothermally.

The temperature of the fluidized beds in the separator 128 can be controlled. The fluidized beds are operated isothermally, or near isothermally. The flue gas 600 moves at a gas velocity of approximately 0.3-5.0 m/s; the exact gas velocity is based on the sorbent particle size and particle density. The sorbent properties and the flue gas flow rate are such that the sorbent is fluidized in the Geldart A bubbling bed fluidized regime.

Although only three stages of fluidized beds are shown, the actual number of stages is varied based on the sorbent properties. Because the number of stages can be varied based on sorbent properties the separator in FIG. 6 is shown with a break in the equipment in the bottom bed 400 of stage 308c. In FIG. 6, the gas flows from the bottom fluidized bed of stage 308c to the top fluidized bed of stage 308a and the CO₂ concentration in the gas stream decreases during each stage. The CO₂ concentration in the flue gas is the lowest above the top fluidized bed of stage 308a. After the top (i.e. first) fluidized bed stage 308a, the CO₂-lean flue gas is directed through two cyclones 616 in series and a baghouse 620. The cyclones 616 return any captured sorbent back to the separator 128. The baghouse 620 is designed to remove sorbent too fine to be captured by the cyclones. Depending on sorbent properties this material may be returned to the separator 128 or may be deemed too small and be considered a waste product. Depending on sorbent properties, one or more of these particulate matter collection devices may not be necessary.

The CO₂-lean sorbent 204 is introduced into the separator 128 in the first fluidized bed stage 308a, which is on the top of the separator 128. The introduction point is below the upper solids level of the bed 400 to ensure adequate mixing and substantially minimize or inhibit short circuiting to a different bed 400. Under normal operating conditions, the sorbent is withdrawn from the bed 400 at substantially the same rate that it is added so that no net accumulation occurs. The sorbent, via down comers 350, moves from the first stage to the next stage. The down comers 350 are slightly fluidized to allow the sorbent to move from one stage to the next. The fluidization gas could be N₂, air, flue gas, CO₂ lean flue gas, steam, or CO₂, depending on the sorbent properties and the desired operating conditions. As the sorbent moves from one stage to the next, it becomes loaded with CO₂. The cooling device(s) (e.g., coils) 316 in each fluidized bed 400 remove at least most of the heat generated by the adsorption of CO₂. It is possible that other gases, such as moisture, could also be sorbed by the sorbent. The cooling coils can be sized to also remove the heat generated by any other heat of reactions.

The sorbent in the beds is well mixed and fluidized appropriately to achieve the mass transfer and heat transfer demonstrated by the bubbling bed fluidization regime. For one particular sorbent, the bulk density is 320-480 kg/m³, depending on the moisture level. The fluidized bed density in all of the fluidized beds in the CO₂ capture process, described in terms of ΔP/L is 160 to 400 kg/m³ depending on the sorbent and the fluidization gas velocity. The fluidized bed density is highly dependent on several operational factors that can be varied, including gas velocity, particle density, particle shape, etc. The height of each of the beds, the tops of which are shown using the dashed lines in the separator and regenerator, can be varied, but in most cases it will be determined by the amount of sorbent required to fully cover the cooling coils 316.

The height of the cooling coils 316 is dictated by the amount of heat that must be removed in each of the fluidized beds in the separator 128. The separator 128 is designed in such a way that the first (i.e. top in the case) fluidized bed 400 of stage 308a is larger in volume than the subsequent fluidized beds. The first fluidized bed 400 is larger because a greater amount of heat transfer surface area is required. The greater amount of heat exchanger surface area and volume of the first bed 400 can be attributed to the top stage 308a being responsible for the heat extraction required to reduce the temperature of the sorbent from the regenerator temperature to the separator temperature (i.e. sensible heat) as well as remove the heat due to the sorption reaction(s) (i.e. latent heat). Since the sorbent is already at the separator operating temperature when it is introduced to subsequent fluidized beds, those beds are responsible only for removing the latent heat of adsorption, which is highly sorbent dependent and could be approximately 55 to 80 kJ/mol CO₂. Where additional gases are sorbed, the latent heat that must be removed is increased.

The CO₂ loading on the sorbent increases as it moves from the first to the last bed in the separator 128. Sorbent is withdrawn from the bottom bed of stage 308c at a sorbent withdraw rate substantially equal to the overall sorbent circulation rate. The sorbent circulation rate is normally dependent on the sorbent properties (specifically CO₂ delta loading under operating conditions) and the desired rate of CO₂ removal. For the specific sorbent used as the basis of FIG. 6 and a CO₂ removal rate of 90% the sorbent withdraw rate from the last stage 308c of the separator, which is also the sorbent circulation rate, is approximately 4000-8000 tons/hr to obtain 90% CO₂ capture for a coal fired power plant approximately 550 MWₙₑₜ in size, although the sorbent circulation rate is highly dependent on sorbent properties. One specific sorbent will have a loading of 10.5 g CO₂/100 g fresh sorbent at the last stage of the separator; the same sorbent will have a sorbent loading of 3.5 g CO₂/100 g fresh sorbent in the regenerator. Therefore, for this sorbent the CO₂ delta loading is 7.0 g CO₂/100 g fresh sorbent.

The sorbent circulation rate is controlled by a sorbent slide valve 624. The sorbent is pneumatically conveyed from the separator 128 to the regenerator 136. The conveying gas 628 is a compressed CO₂ rich gas stream. Compression is done by a recycle blower 632. The CO₂ rich gas conveying stream is greater than 85% CO₂ by volume.

The CO₂ rich sorbent 200 is conveyed to the regenerator 136. The regenerator 136 has a single fluidized bed with internal heating device(s) 382 (e.g., heat exchange coils). Low pressure steam 660 is sent through the heating coils 382 and condenses on the interior walls and exits as condensate 664, which adds the temperature increase necessary to release CO₂ from the sorbent. Near the sorbent inlet to the regenerator 136 one or more baffles (not shown) are placed to promote sorbent mixing. The average sorbent residence time in the regenerator depends on the bed height and sorbent circulation rate but is commonly less than about five minutes.

The sorbent is fluidized using a CO₂ rich gas stream 628 that has been withdrawn from the product gas stream 132. Some of the gas stream 132, after treatment by cyclones 636 and baghouse 640, produces the CO₂ product stream 132 that can be passed through heat exchanger 658 to cool the stream and compressed for storage or used for some other purpose and lean sorbent fines 654 which are returned to the separator 128. Downstream of the regenerator overhead baghouse 640, some of the gas stream 132 is recycled using the CO₂ recycle blower 632. The recycled gas, which is mostly CO₂, is used to fluidize the CO₂-loaded sorbent bed in the regenerator 136, pneumatically convey loaded sorbent 200 in the rich sorbent riser (from the separator to the regenerator), and pneumatically convey the lean sorbent 204 from the regenerator to the separator in the lean sorbent rise. The sorbent exits the regenerator 136 via a dip leg 650, which is connected to the lean sorbent riser.

The sorbent cycles through the entire adsorption/regeneration process in approximately fifteen minutes or less. Sorbent can be withdrawn from several locations in the process and fresh sorbent can be added if CO₂ removal decreases over time.

To treat the flue gas from a large (i.e. ≧500 MWₙₑₜ) coal-fired power plant, four trains of the process shown in FIG. 6 would be necessary based on the properties of one specific sorbent.

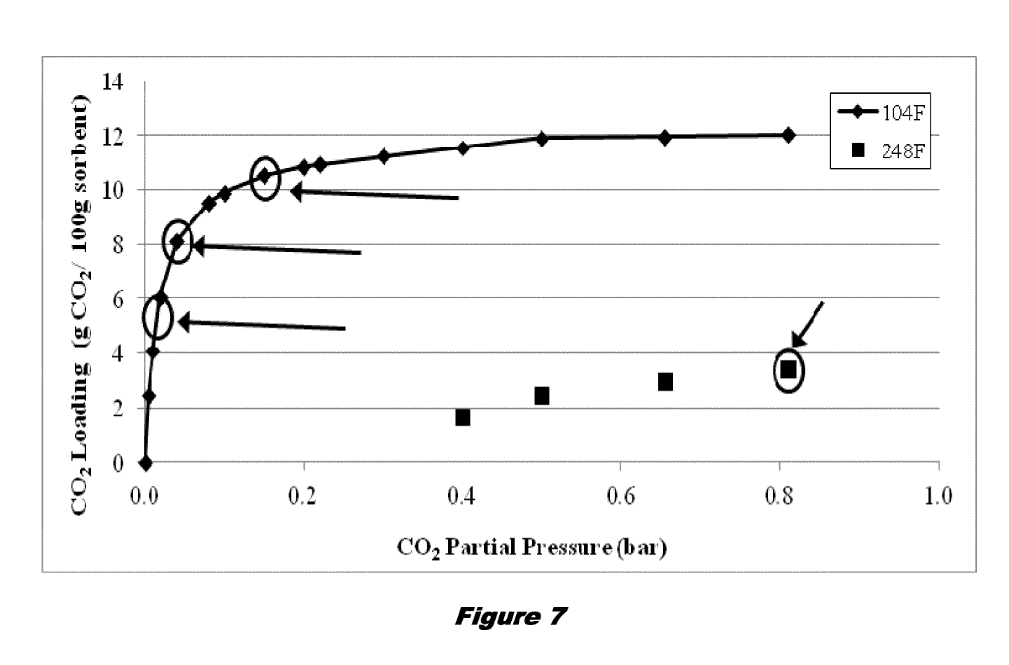

Although the invention has been developed in such a way that it is meant to operate with many different sorbents, there are several sorbent properties that should be understood. A sorbent property of high importance is the CO₂ loading at different temperatures and CO₂ partial pressures. For an ion exchange resin functionalized with an amine the CO₂ loading at different CO₂ partial pressures and temperatures is provided in FIG. 7. Although the CO₂ loading at different temperatures was also measured, only the separator and regenerator operating temperatures from FIG. 6 are shown for the sake of simplicity.

Although the data shown in FIG. 7 was recorded using thermogravimetric analysis in the laboratory, the relationship between sorbent CO₂ loading and gas CO₂ partial pressure can be used to understand operation of the separator and regenerator. Assuming no kinetic limitations, the sorbent leaving the regenerator is 3.5 g CO₂/100 g fresh sorbent at the conditions of P_{CO2}˜0.85 bar and 248° F. (˜120° C.). The sorbent enters the first stage of the separator at the conditions of P_{CO2}˜0.015 bar and 104° F. (40° C.), which results in a CO₂ loading of 5.5 g CO₂/100 g fresh sorbent. The sorbent will then move from the first separator stage 308a to the middle separator stage 308b, which is operating at the conditions of P_{CO2}˜0.6 bar and 104° F. (40° C.), which results in a sorbent CO₂ loading of 8 g CO₂/100 g fresh sorbent. After the middle stage 308b the sorbent will move to the last stage 308c, which operates under the conditions of P_{CO2}˜0.15 bar and 104° F. (40° C.), which results in a CO₂ loading of 10.5 g CO₂/100 g fresh sorbent. The difference between the CO₂ loading in the last separator stage and the regenerator is considered the sorbent delta CO₂ loading, which is approximately 7.0 g CO₂/100 g fresh sorbent in this case. If the separator was not staged and only a single fluidized bed was used the P_{CO2}, CO₂ loading in the separator, and delta CO₂ loading would be lower. This would result in a larger sorbent circulation rate and a larger sensible heat requirement. Thus, staged fluidized beds in the separator is a superior means of loading CO₂ onto a sorbent that will be regenerated.

A number of variations and modifications of the disclosure can be used. It would be possible to provide for some features of the disclosure without providing others. The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving a gas stream comprising a target constituent to be removed by a solid sorbent;
fluidizing a bed of the sorbent with the gas stream to sorb the target constituent on the solid sorbent; and
removing a target constituent-loaded sorbent from the bed, wherein a distributor positioned below the sorbent bed comprises stacked distributor elements, with a first row of distributor elements being positioned above a second row of distributor elements and wherein an upper distributor element in the first row of distributor elements overlaps an adjacent lower distributor element in the second row of distributor elements.

2. The method of claim 1, wherein the distributor elements are substantially fixed to a housing containing the fluidized bed in response to movement of the fluidized gas.

3. The method of claim 1, wherein the distributor elements are inversely “V”-shaped.

4. The method of claim 1, wherein an upper distributor element in the first row vertically overlaps a lower distributor element in the second row.

5. The method of claim 1, wherein a base of the upper distributor element in the first row is spaced from a side of the lower distributor element in the second row, wherein the fluidizing step is performed under conditions to produce bubbling bed fluidization, and wherein the solid sorbent is, under the conditions, a Geldart A material.

6. The method of claim 5, wherein a gap between the base of the upper element and side of the lower element is sufficiently large to maintain at least most of the solid sorbent in the fluidized bed during fluidization.

7. The method of claim 1, wherein an apex of each distributor element defines a line extending substantially a width of the fluidized bed and wherein the lines defined by a plurality of the distributor elements are substantially parallel.

8. The method of claim 1, wherein a base apex of each distributor element defines a line extending substantially a width of the fluidized bed and wherein the lines defined by a plurality of the distributor elements are substantially parallel.

9. The method of claim 1, wherein an upper distributor element in the first row laterally overlaps a lower distributor element in the second row.

10. A system, comprising:
an input to receive a gas stream comprising a target constituent to be removed by a solid sorbent;
a fluidized bed of the sorbent to sorb the target constituent on the solid sorbent;
a distributor positioned below the sorbent bed comprising stacked distributor elements, with a first row of distributor elements being positioned above a second row of distributor elements and wherein an upper distributor element in the first row of distributor elements overlaps an adjacent lower distributor element in the second row of distributor elements; and
an output to output a treated gas stream having a substantially reduced concentration of the target constituent.

11. The system of claim 10, wherein the distributor elements are substantially fixed in response to movement of the fluidized gas.

12. The system of claim 10, wherein the distributor elements are inversely “V”-shaped.

13. The system of claim 10, wherein an upper distributor element in the first row vertically overlaps a lower distributor element in the second row.

14. The system of claim 10, wherein a base of the upper distributor element in the first row is spaced from a side of the lower distributor element in the second row, wherein the fluidizing step is performed under conditions to produce bubbling bed fluidization, and wherein the solid sorbent is, under the conditions, a Geldart A material.

15. The system of claim 14, wherein a gap between the base of the upper element and side of the lower element is sufficiently large to maintain at least most of the solid sorbent in the fluidized bed during fluidization.

16. The system of claim 10, wherein an apex of each distributor element defines a line extending substantially a width of the fluidized bed and wherein the lines defined by a plurality of the distributor elements are substantially parallel.

17. The system of claim 10, wherein a base apex of each distributor element defines a line extending substantially a width of the fluidized bed and wherein the lines defined by a plurality of the distributor elements are substantially parallel.

18. The system of claim 10, wherein an upper distributor element in the first row laterally overlaps a lower distributor element in the second row.

19. A system, comprising:
a distributor positioned below a fluidized solid sorbent bed comprising stacked and substantially fixed distributor elements, with a first row of distributor elements being positioned above a second row of distributor elements and wherein an upper distributor element in the first row of distributor elements overlaps an adjacent lower distributor element in the second row of distributor elements.

20. The system of claim 19, wherein the distributor elements are substantially fixed to a housing containing the fluidized bed in response to movement of the fluidized gas.

21. The system of claim 19, wherein the distributor elements are inversely “V”-shaped.

22. The system of claim 19, wherein an upper distributor element in the first row vertically overlaps a lower distributor element in the second row.

23. The system of claim 19, wherein a base of the upper distributor element in the first row is spaced from a side of the lower distributor element in the second row and wherein the solid sorbent is, under the conditions, a Geldart A material.

24. The system of claim 23, wherein a gap between the base of the upper element and side of the lower element is sufficiently large to maintain at least most of the solid sorbent in the fluidized bed during fluidization.

25. The system of claim 19, wherein an apex of each distributor element defines a line extending substantially a width of the fluidized bed and wherein the lines defined by a plurality of the distributor elements are substantially parallel.

26. The system of claim 19, wherein a base apex of each distributor element defines a line extending substantially a width of the fluidized bed and wherein the lines defined by a plurality of the distributor elements are substantially parallel.

27. The system of claim 19, wherein an upper distributor element in the first row laterally overlaps a lower distributor element in the second row.
